(19) United States
(12) Patent Application Publication
(10) Pub. No.: US 2010/0316359 A1
(43) Pub. Date: Dec. 16, 2010

(54) ENHANCING DVDs BY SHOWING LOOPING VIDEO CLIPS

(76) Inventor: James Mally, Roseville, CA (US)

Correspondence Address: HAVERSTOCK & OWENS LLP, 162 N WOLFE ROAD, SUNNYVALE, CA, 94086, US

(21) Appl. No.: 12/792,060

(22) Filed: Jun. 2, 2010

Related U.S. Application Data
(60) Provisional application No. 61/186,060, filed on Jun. 11, 2009.

(51) Int. Cl. H04N 5/91

(52) U.S. Cl. 386/343; 386/E05.061

(57) ABSTRACT

Enhancing DVDs by showing looping video clips is described herein. The looping is able to be implemented in a device, a system and a method. The looping is able to be implemented on the DVDs by writing the DVDs in a specified looping configuration or another implementation that configures the DVDs to loop as desired. The looping is able to be implemented on a DVD player so that the DVD player is configured to loop as desired. The looping enables video clips of a DVD to be repeated until desired, unlike a standard DVD which plays each clip or chapter once and continues to the next chapter. This looping is able to enhance learning by providing repetitive examples of techniques without the user having to continuously intervene.

### RELATED APPLICATIONS

The present application claims priority of U.S. Provisional Patent Application No. 61/186,060, filed on Jun. 11, 2009, and entitled “ENHANCING DVDs BY SHOWING LOOPING VIDEO CLIPS,” under U.S.C. § 119(e). This application incorporates U.S. Provisional Patent Application No. 6/186,060, filed on Jun. 11, 2009, and entitled “ENHANCING DVDs BY SHOWING LOOPING VIDEO CLIPS” by reference in its entirety.

### FIELD OF THE INVENTION

The present invention relates to video. More specifically, the present invention relates to enhancing DVDs by showing looping video clips.

### BACKGROUND OF THE INVENTION

A Digital Versatile Disc (DVD) with a video is typically broken up into chapters. Generally when a user plays the DVD, the video plays continuously until it reaches an end unless the user intervenes. For educational videos, a user may replay a video or a segment of a video to fully learn what is being taught on the video. To do this, the user is forced to stop what he or she is doing and push the appropriate buttons so that the video returns to the starting point of the educational lesson and resumes play of the lesson. Not only does this distract the user, but the process of restarting the video is time consuming.

### SUMMARY OF THE INVENTION:

Enhancing DVDs by showing looping video clips is described herein. The looping is able to be implemented in a device, a system and a method. The looping is able to be implemented on the DVDs by writing the DVDs in a specified looping configuration or another implementation that configures the DVDs to loop as desired. The looping is able to be implemented on a DVD player so that the DVD player is configured to loop as desired. The looping enables video clips of a DVD to be repeated until desired, unlike a standard DVD which plays each clip or chapter once and continues to the next chapter. This looping is able to enhance learning by providing repetitive examples of techniques without the user having to continuously intervene.

In one aspect, a method of playing a disc comprises playing a video segment stored on the disc and looping the video segment automatically without user intervention. The method further comprises selecting a slide containing the video segment. The slide contains the video segment and at least an additional video segment. The video segment and the additional video segment are a same technique but from different vantage points. The looping continues until a user stops the looping. The looping continues for a pre-determined number of times. The looping is implementing using at least one of a pointer, link and an address. The video segment is silent. Alternatively, the video segment includes audio instructions. The video segment includes written instructions. The disc is selected from the group consisting of a Digital Versatile Disc (DVD), a Compact Disc (CD), a Blu-ray disc and a High Definition DVD (HD-DVD).

In another aspect, an apparatus comprises a computer readable disc and a looping implementation configured to automatically loop a video segment on the computer readable disc. The computer readable disc is selected from the group consisting of a Digital Versatile Disc (DVD), a Compact Disc (CD), a Blu-ray disc and a High Definition DVD (HD-DVD). The computer readable disc continues looping until a user stops the looping implementation. The computer readable disc continues looping for a pre-determined number of times. The looping implementation includes at least one of a pointer, link and an address, and further wherein the looping implementation loops to the beginning of the video segment. The video segment is silent. Alternatively, the video segment includes audio instructions. The video segment includes written instructions.

In another aspect, a method of learning using a disc comprises displaying a slide including a video segment with educational steps, looping the video segment automatically without user intervention and physically repeatedly performing the educational steps. The method further comprising performing an action then selecting the results of the action, where a next slide shows a next step based on the selected results. The method wherein the action is an orthopedic test.

In another aspect, a system comprises a looping Digital Versatile Disc (DVD) configured for continuously looping without user intervention, a player configured for playing the looping DVD and outputting a video signal, a display configured for displaying the video signal and a remote control configured for providing input to the player.

In yet another aspect, a device comprises a reading component for reading a Digital Versatile Disc (DVD) and a looping component for automatically looping a segment of the DVD while the DVD is being read.

### BRIEF DESCRIPTION OF THE DRAWINGS

FIG. 1 illustrates an exemplary video clip with a written description according to some embodiments.

FIG. 2 illustrates exemplary selectable video segments according to some embodiments.

FIG. 3 illustrates an exemplary screenshot with multiple selectable video clips according to some embodiments.

FIG. 4 illustrates an exemplary video clip of a test according to some embodiments.

FIG. 5 illustrates a flowchart of a method of looping a video segment of a DVD according to some embodiments.

FIG. 6 illustrates a flowchart of a method of educational training using a looping DVD according to some embodiments.

FIG. 7 illustrates a block diagram of a looping implementation according to some embodiments.

FIG. 8 illustrates a DVD system according to some embodiments.

### DETAILED DESCRIPTION

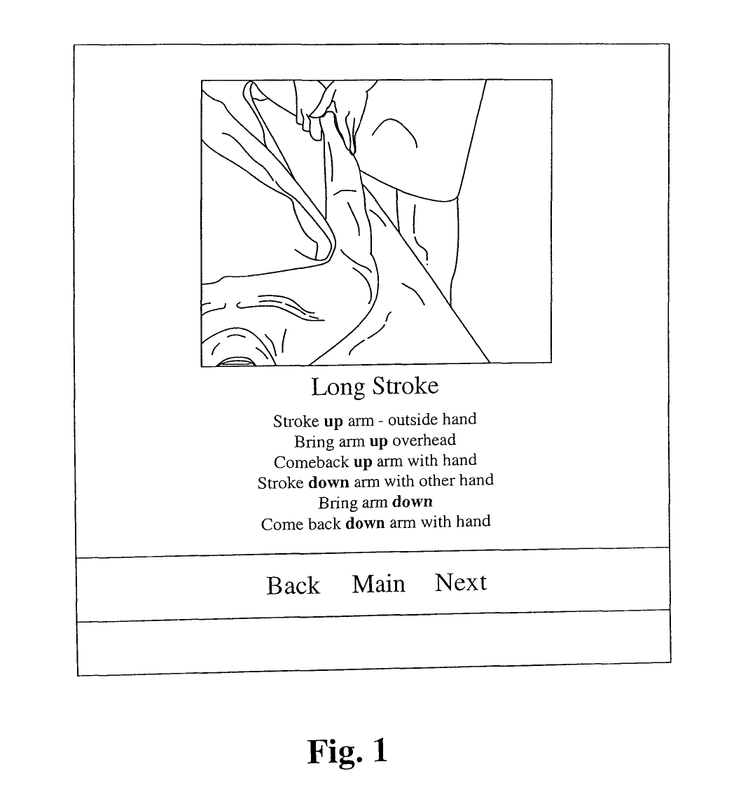

Perpetual Play™ is a process for enhancing educational Digital Versatile Discs (DVDs) (also referred to as Digital Video Discs) by showing looping video clips of techniques. DVDs enhanced with this process will play in any standard DVD player. Perpetual Play™ enables the DVD to play like a slide show. Viewers are able to spend as much time as they desire/need on a particular slide before moving on to the next slide. The looping video clip(s) will play continuously on a slide until another slide is selected, allowing the viewer to practice techniques shown on that slide. Written instructions are also able to be on a slide to help clarify the content of the video clips, as shown in FIG. 1. In some embodiments, the video clips are silent since the endless repetition of the soundtrack could be irritating. Slides are able to have one or more looping video clip, and the inclusion of audio on multiple video clips could be cacophonous. In some embodiments, where a slide includes multiple video clips, the video clips are of the same technique but from different vantage points.

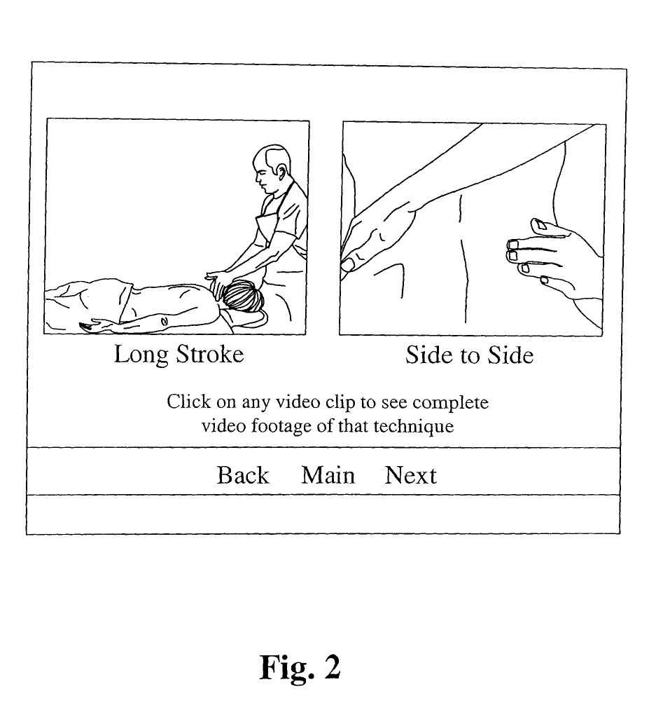

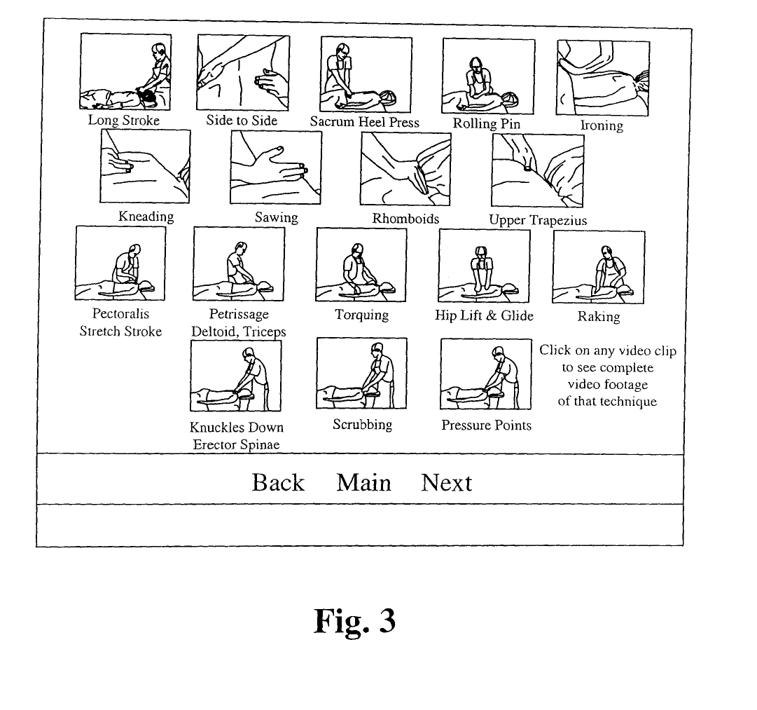

Selecting any video clip with the remote control and clicking on the video clip will show the viewer the actual video content, and in some embodiments, with text and/or audio instructions. FIG. 2 shows a slide of video segments available to be selected. Once the video segment of the DVD is shown, the segment will automatically continue looping without user intervention. In some embodiments, the DVD returns to the slide where a user is able to select video clip(s). Multiple looping video clips are able to be shown on one screen to facilitate easy practice of techniques, as shown in FIG. 3.

The viewer is also able to have selections available to view sections of the DVD or the entire DVD straight through without interruption.

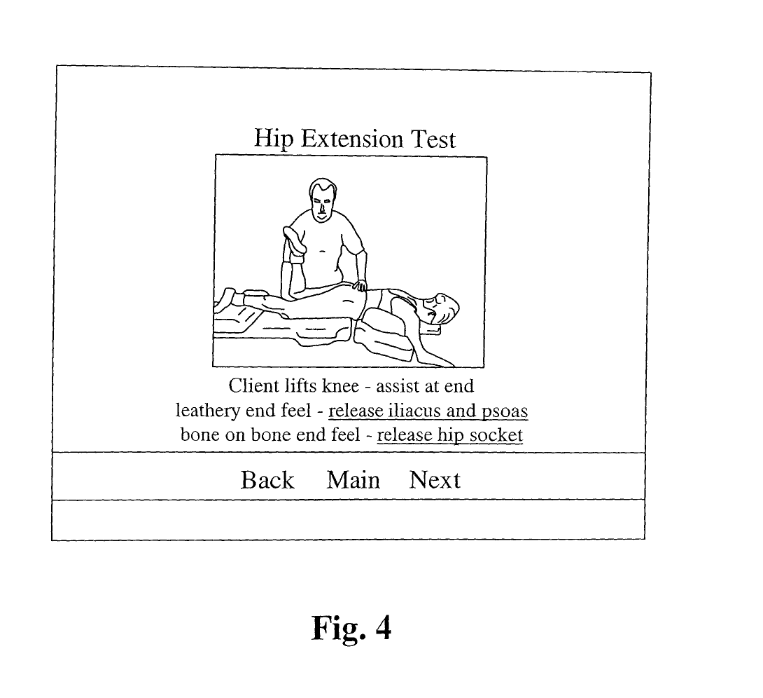

Training algorithms are also able to be incorporated into the DVDs. For example, a DVD on orthopedic massage techniques is able to show an orthopedic test. The viewer is able to perform the test, and then select the result of the test with the remote and go to a screen that will show the next step based on their selection, as is shown in FIG. 4.

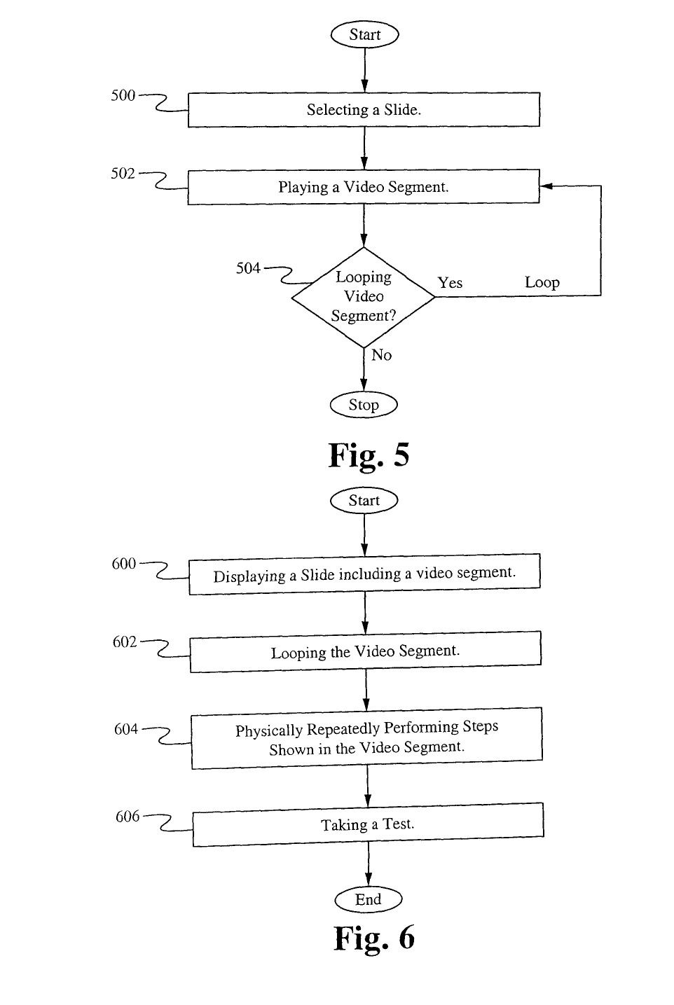

FIG. 5 illustrates a flowchart of a method of looping a video segment of a DVD according to some embodiments. In the step 500, a slide is selected. In the step 502, one or more video segments play. In some embodiments, in the step 502, a video segment is selected and then the video segments are played. In some embodiments, the step 500 is omitted, and the video segment(s) begin playing automatically. In the step 504, it is determined if the video segment is to be looped. If the video segment is to be looped, the video segment resumes playing the video segment at the beginning of the segment. If the video segment is not to be looped, the video segment is stopped, either by stopping playing the DVD, going to another video segment or another implementation. In some embodiments, the video segment is automatically looped without user intervention until a user stops the looping (e.g. by pressing stop or skip on a remote control). In some embodiments, the video segment is automatically looped for a pre-determined number of times. In some embodiments, a counter is used to ensure the number of loops is achieved properly.

FIG. 6 illustrates a flowchart of a method of educational training using a looping DVD according to some embodiments. In the step 600, a slide is displayed including a video segment. In the step 602, the video segment is played and looped automatically without user intervention. In the step 604, while the video segment is playing/looping, a user physically performs the steps shown in the video segment to learn and/or practice. For example, a video segment of teaching a massage technique is played and looped while a user attempts to mimic the technique by performing the displayed technique. The techniques are able to be any technique including, but not limited to, massage, chiropractics, medical procedures, languages and any other techniques that are aided in learning by repetition. In the step 606, in an interactive testing mode, a user takes a test by selecting an answer for the test, where a next slide shows a next step based on the selected answer. In some embodiments, the selection is based on the result of the step 604. For example, if a user is practicing massage and massages a person's shoulder, and after the shoulder massage, the person complains of lower back pain, the next slide will be a massage technique related to lower back pain. The testing step 606, is implemented in the interactive testing mode, and a standard training mode does not utilize testing.

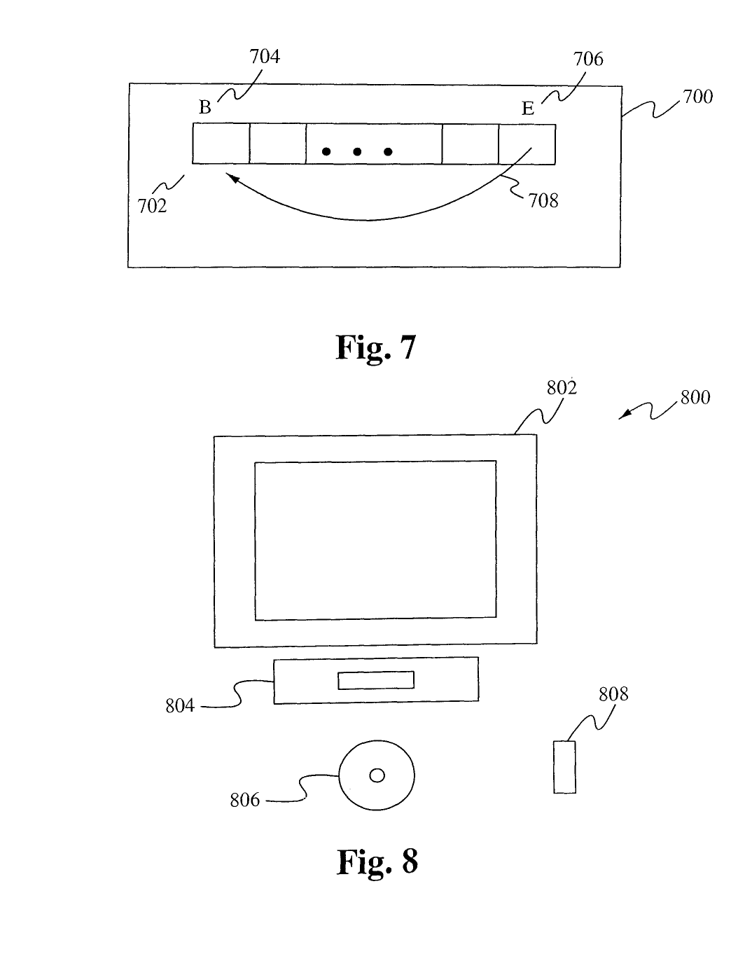

FIG. 7 illustrates a block diagram of a looping implementation according to some embodiments. A DVD segment 700 includes a data structure 702 (such as an array or a linked list) of data (such as a slide, a video segment or a slide containing a video segment) with a beginning 704 and an end 706. The data structure 702 is able to store one or more kinds of data. At the end 706 of the data structure 702, a looping implementation 708 such as pointer, link, address or other implementation is used to loop the video back to the beginning 704 of the data structure 702. For example, the address of the beginning 704 is addr[0100] and the data stored at the end 706 of the data structure 702 is a jump operation to addr[0100], so that when the end 706 is reached, it automatically goes to the beginning In some embodiments, the data structure is a circularly-linked list. In some embodiments, the data structure is a table, a database or any other structure. In some embodiments, a beginning address is included at the end of the video segment without a particular structure.

FIG. 8 illustrates a DVD system 800 according to some embodiments. A display 802 such as a television or monitor is configured to display information such as slides and/or video segments. The display 802 is coupled to a player 804 such as a DVD player or Blu-ray player. The display 802 receives the signal from the player 804 and displays the video. The player 804 is configured to receive and play a disc 806 such as a DVD, Blu-ray disc or any other disc. In some embodiments, the disc 806 itself is written or configured to include the looping feature and the player 804 is a standard player. In some embodiments, the player 804 includes typical player components but is also configured to implement the looping feature, and the disc 806 is a standard disc. In some embodiments, a remote 808 is able to be used to operate the player 804, for example, to jump to a next slide or video segment, to select a video segment or any other operations able to be performed remotely. The looping feature is able to be software, hardware, firmware or any combination thereof.

Although the looping implementation described herein is directed to DVDs, the looping implementation is able to be applied to any media, including but not limited to, DVDs, CDs, Blu-ray discs, HD-DVDs and any other media. Similarly, although a DVD player is described herein, any player is able to be used, including but not limited to, a DVD player, a CD player, a Blu-ray player, an HD-DVD player and any other appropriate player. In some embodiments, the media is not a disc, but any other type of readable media that implements the looping implementation.

To utilize the enhanced DVDs, a user inserts a DVD into a player and initiates the DVD as is typically performed with a DVD. However, when playing the DVD, the DVD loops one or more of the video segments contained on the DVD. For example, educational techniques are stored as slides and/or video segments on the DVD, and each video segment is automatically looped until a user stops the DVD or continues to another video segment. While the DVD is playing and looping, a user is able to use the video to learn and replicate techniques or other information displayed.

In operation, the enhanced DVDs automatically loop video segments so that they are repetitiously replayed without user intervention. By looping automatically, a user avoids having to stop what he/she is doing, thus providing a better learning environment for a user learning and/or training using the DVD. Furthermore, since the looping is incorporated in the DVD, a user does not even have to press a button to loop, whereas CD players which have a selectable repeat function require a user to select repeat by physically pressing a button for the repeating to occur.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the device and method of the present invention could be implemented in several different ways and have several different appearances.

We claim:

1. A method of playing a disc comprising:
a. playing a video segment stored on the disc; and
b. looping the video segment automatically without user intervention.

2. The method of claim 1 further comprising selecting a slide containing the video segment.

3. The method of claim 2 wherein the slide contains the video segment and at least an additional video segment.

4. The method of claim 3 wherein the video segment and the additional video segment are a same technique but from different vantage points.

5. The method of claim 1 wherein the looping continues until a user stops the looping.

6. The method of claim 1 wherein the looping continues for a pre-determined number of times.

7. The method of claim 1 wherein the looping is implementing using at least one of a pointer, link and an address.

8. The method of claim 1 wherein the video segment is silent.

9. The method of claim 1 wherein the video segment includes audio instructions.

10. The method of claim 1 wherein the video segment includes written instructions.

11. The method of claim 1 wherein the disc is selected from the group consisting of a Digital Versatile Disc (DVD), a Compact Disc (CD), a Blu-ray disc and a High Definition DVD (HD-DVD).

12. An apparatus comprising:
a. a computer readable disc; and
b. a looping implementation to automatically loop a video segment on the computer readable disc.

13. The apparatus of claim 12 wherein the computer readable disc is selected from the group consisting of a Digital Versatile Disc (DVD), a Compact Disc (CD), a Blu-ray disc and a High Definition DVD (HD-DVD).

14. The apparatus of claim 12 wherein the computer readable disc continues looping until a user stops the looping implementation.

15. The apparatus of claim 12 wherein the computer readable disc continues looping for a pre-determined number of times.

16. The apparatus of claim 12 wherein the looping implementation includes at least one of a pointer, link and an address, and further wherein the looping implementation loops to the beginning of the video segment.

17. The apparatus of claim 12 wherein the video segment is silent.

18. The apparatus of claim 12 wherein the video segment includes audio instructions.

19. The apparatus of claim 12 wherein the video segment includes written instructions.

20. A method of learning using a disc comprising:
a. displaying a slide including a video segment with educational steps;
b. looping the video segment automatically without user intervention; and
c. physically repeatedly performing the educational steps.

21. The method of claim 20 further comprising performing an action then selecting the results of the action, where a next slide shows a next step based on the selected results.

22. The method of claim 21 wherein the action is an orthopedic test.

23. A system comprising:
a. a looping Digital Versatile Disc (DVD) configured for continuously looping without user intervention;
b. a player configured for playing the looping DVD and outputting a video signal;
c. a display configured for displaying the video signal; and
d. a remote control configured for providing input to the player.

24. A device comprising:
a. a reading component for reading a Digital Versatile Disc (DVD); and
b. a looping component for automatically looping a segment of the DVD while the DVD is being read.
